(19) United States
(12) Patent Application Publication
(10) Pub. No.: US 2024/0025086 A1
(43) Pub. Date: Jan. 25, 2024

(54) METHOD AND SYSTEM FOR SEPARATING PLASTICS FROM A WASTE STREAM

(71) Applicant: Thomas A. VALERIO, Atlanta, GA (US)

(72) Inventor: Thomas A. VALERIO, Atlanta, GA (US)

(21) Appl. No.: 18/481,775

(22) Filed: Oct. 5, 2023

Related U.S. Application Data
(63) Continuation of application No. PCT/US2022/071580, filed on Apr. 6, 2023.
(60) Provisional application No. 63/171,532, filed on Apr. 6, 2021.

(51) Int. Cl. B29B 17/02; B03B 9/06

(52) U.S. Cl. CPC B29B 17/02; B03B 9/061; B03B 2009/068

(57) ABSTRACT

A method for separating and recovering plastics from a waste stream including size separating the waste material, comminuting the material, and separating material at a specific density between 1.0 and 1.1 SG. Systems are included herein. PP and PE are separated from the waste stream.

### TECHNICAL FIELD

This application relates to separating various materials in a waste stream (e.g., ASR or ESR). This application also relates to removing plastics from a waste stream. This application also relates to material separations in which plastics from waste streams are separated from waste plastic materials and other materials.

### BACKGROUND

Recycling of waste materials is highly desirable from many viewpoints, not the least of which are financial and ecological. Properly sorted recyclable materials can often be sold for significant revenue. Many of the more valuable recyclable materials do not biodegrade within a short period, and so their recycling significantly reduces the strain on local landfills and ultimately the environment.

Most of the plastic supplied by today's manufacturers ends its life in landfills or incinerators simply because the technology has not been available to recover it economically. Durable goods, such as automobiles, appliances and electronics equipment, account for more than one-third of the plastics in municipal solid waste. Durable goods are increasingly being collected and partially recycled at the end of their useful lives to avoid disposal costs and potential liabilities, and to recover metals and other marketable raw materials.

Automobile shredder residue (ASR) and electronic waste shredder residue (ESR) feed materials are very diverse and contain rubber, wood, metal, wires, circuit boards, foam, glass and other non-plastics. When plastic materials are to be recycled, the plastic materials should be separated into multiple product and byproduct streams. Generally, the recycling processes need to be applied to a variety of plastics-rich streams derived from post-industrial and post-consumer sources to be useful commercially.

Different grades of a given plastic type can be compatible. Some grades can generally be melt mixed to create a new material with a different property profile. A variety of plastics may be contained within a waste stream. Some such plastics include polypropylene (PP); polyethylene (PE); acrylonitrile butadiene styrene (ABS); polystyrene (PS), including high impact polystyrene (HIPS), and polyvinyl chloride (PVC). These materials are more valuable if separated, at least into “light” plastics (PP and PE) and “heavy” plastics (ABS and PS). Also, some plastics are undesirable, such as PVC and some PP, such as talc-filled and glass-filled PP. To increase the value of the segregated plastics, the undesirable plastics should be removed from the mixture so to create a more uniform material.

Many processes for identifying and separating materials are known in the art. However, not all processes are efficient for recovering plastics and the sequencing of these processes is one factor in developing a cost-effective recovery process. Accordingly, there is always a need for improved methods and systems for recovering plastics from a waste stream.

### SUMMARY

One aspect includes a method for recovering plastics from a waste stream. The method can include the steps of size separating the waste material at between 19 to 25 mm from the waste stream into a first undersized material and a first oversized material, comminuting the first undersized material into a first residue by mechanical comminution, sizing the first residue into a second undersized material and a second oversized material, separating the second oversized material at a specific density between 1.0 and 1.1 SG into a first heavy fraction and a first light fraction, separating the first light fraction at greater than 4 mm into third sized material and a third oversized material; and collecting the third oversized material. The third oversized material is more than 90% PP and PE.

Another aspect includes a system for separating and recovering plastics from a waste stream having a feeder having a waste material, a first screen separating the material below 25 mm into a first sized material and a first oversized material, a comminutor for comminuting the sized material into a first residue by mechanical comminution, and a second screen for sizing the first residue into a second undersized material and a second oversized material, a first density separator for the second oversized material at a specific density between 1.0 and 1.1 SG into a first heavy fraction and a first light fraction, a third screen for separating the first light fraction above 8 mm into third sized material and a third oversized material, and a collector the third oversized material, wherein the third oversized material can be more than 90% PP and PE.

Another aspect includes a system for separating and recovering plastics from a waste stream including a first screen separating the material below 25 mm into a first sized material and a first oversized material, a comminutor for comminuting the sized material into a first residue by mechanical comminution, a second screen for sizing the first residue into a second sized material and a second oversized material, a first density separator for the second oversized material at a specific gravity between 1.0 and 1.1 SG into a first heavy fraction and a first light fraction, a third screen for separating the first light fraction above 8 mm from the waste stream into third sized material and a third oversized material, and a collector for the third oversized material. The third oversized material can be more than 90% PP and PE.

Another aspect includes a system having a third density separator for separating the second sized material at a specific density at 1.2 SG into a third heavy fraction and a third light fraction.

Another aspect includes a system having a fourth screen for separating the third light fraction at 0.5 mm, into a fourth sized material and a fourth oversized material. The fourth oversized material is substantially ABS and PS.

### DESCRIPTION OF FIGURES

FIG. 1 is a flow diagram of one embodiment of the invention;

FIG. 2 is a flow diagram of another embodiment of the invention; and

FIG. 3 shows an exemplary system according to a specific embodiment of the invention.

### DETAILED DESCRIPTION

Exemplary embodiments of this invention provide methods and systems for sorting plastics from waste material. Such embodiments provide processes and systems for separating plastics with multiple processing steps, which can result in streams of light plastics and heavy plastics. The methods include defining an arrangement to prepare a recycled plastic product. Further, specific methods and systems can allow for the removal of undesirable plastics and non-plastics from a stream so to produce product of a single plastic type. Specific embodiments provide cost-effective, efficient methods and systems for recovering plastics from a waste stream, such as materials seen in a recycling process, including polypropylene (PP), polyethylene (PE), acrylonitrile-butadiene-styrene (ABS) and polystyrene (PS), in a manner that facilitates revenue recovery while also reducing landfill requirements.

The initial waste streams contain amounts of rubber, wood, metal, wires, circuit boards, foam, glass and other non-plastics. Size reduction methods and systems configured to perform the processes have been developed such that feed streams rich in plastics can be separated into multiple products and byproduct streams. The methods and systems can be applied to a variety of plastics-rich streams derived from post-industrial and post-consumer sources. These streams can include plastics from office automation equipment (printers, computers, copiers, etc.), white goods (refrigerators, washing machines, etc.), consumer electronics (televisions, video cassette recorders, stereos, etc.), automotive shredder residue, packaging waste, household waste, building waste and industrial molding and extrusion scrap. This material can be processed by specific embodiments of this invention.

Specific embodiments allow the material from the waste stream to be purified or separated to remove undesirable plastics and non-plastics from a stream of a family of multiple plastic types. Plastics from more than one source of durable goods may be included in the mix of materials fed to a plastics recycling plant. Exemplary plastics include acrylonitrile-butadiene-styrene (ABS), high impact polystyrene (HIPS), polystyrene (PS), polypropylene (PP), polyethylene (PE), polycarbonate (PC), polyamides (PA), polymethyl methacrylate (PMMA), polyvinyl chloride (PCV), polyether ether ketone (PEEK), polysulfone (PSU), polyoxymethylene (POM) and others. Plastic-bearing materials can be separated into light plastics from heavy plastics. After the materials are separated, the purified plastics can be concentrated, extruded, and pelletized.

Exemplary embodiments provide systems and methods for recovering materials such as plastic. In one aspect of the invention, a method for recovering various plastics from a waste material is provided. The method includes the steps of: (a) removing waste materials from the waste material; (b) screening or size separating the waste materials based on a size less than 25 mm; (c) grinding or comminuting the waste materials; (d) introducing at least one gravity separation at about 1.0 Specific Gravity or SG (e.g., at range of 1.0 SG to 1.1. SG); and (e) collecting desired plastics of various types throughout the process. Various materials collected throughout the process can be discarded or processed using other methodology.

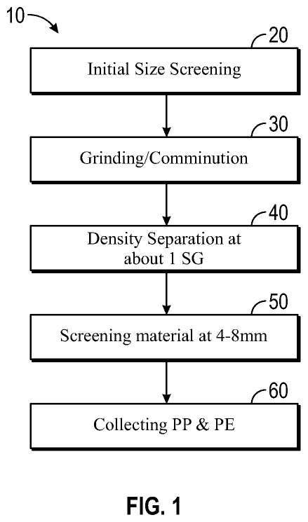

As shown in FIG. 1, the method 10 can start with the waste stream or feed material being initially screened 20 at sizes less 25 mm. For example, a useful multi-stage screen can allow waste materials about 25 millimeters (mm) or less to pass through and allows materials about 17 mm or less to pass through. The sizes of the screen may vary, e.g., one screen may be 10 mm and the other screen may be 50 mm. The sizing or screen sizes may be optimized accordingly.

After the waste materials are initially screened 20, the materials are ground, crushed or otherwise comminuted at this step 30. The waste material is comminuted by, for example, any combination of crushing, shredding, to separate the plastic materials from the waste material. In one embodiment, the waste materials are crushed in a hammer mill, resulting in a powder and larger pieces of plastics. The powders may be separated from the stream by way of a screen, sieve, shaker table, classifier, combinations thereof, and/or other known mechanisms. In one embodiment, the waste materials are comminuted using a ball mill or rod mill.

After the comminution step 30, the materials are separated at a specific density between 1.0 and 1.1 SG into a first heavy fraction and a first light fraction 40.

After the materials are comminated and separated by density, the larger pieces are screened 50 to separate collect the material at a range between 4 mm and 8 mm. In one example, the materials are cut or size separated at 4 mm, 5 mm, 6 mm, 7 mm, 8 mm, or a size between the same. In one example, the material is cut sized separated at 6 m or greater. The oversized material can be more than 65%, 70%, 80%, 85%, 90% PP and PE and is collected accordingly

The methods and systems can include multiple size reduction steps. Size reduction typically includes one or more processes at the front end of a plastics recycling plant that are arranged to accomplish a variety of tasks. Size reduction can be implemented to remove metals that can damage the size reduction process equipment or that can negatively affect downstream separation processes, to reduce the plastic particle size such that much of the non-plastic material is liberated, to create a relatively narrow particle size distribution, and possibly to stabilize or clean the composition of materials sent to downstream processes.

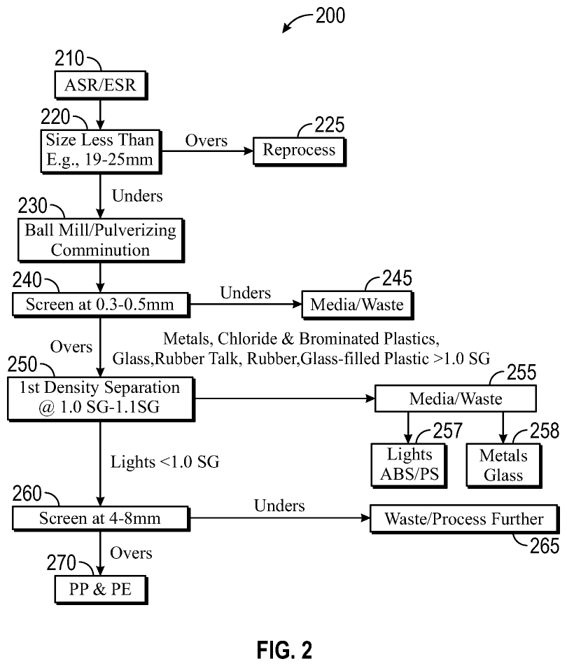

As shown in FIG. 2, one exemplary method 200 includes ASR or ESR feed materials 210 as an initial starting material, which may have been preprocessed. Initially, the feed material is cut or size separated 220 at 200 mm, 100 mm, 50 mm, 25 mm or less. In one example, the feed material entering the process is less than 200 mm. In other examples, the feed material entering the process has a size from 0.1 mm to 25 mm. The material contains rubber, wood, metal, wires, circuit boards, foam, glass and other non-plastics, any or all of which may be reprocessed 225. Material less than 25 mm are then comminuted 230, e.g., by a ball mill or rod mill. The materials from the comminution step 230 may screen at, e.g., 0.3 to 0.5 mm, and the unders may be discarded or used as media 245. Thereafter, the overs are processed at a first gravity separation stage 250 and are separated at an SG or Specific Gravity of about 1.0 to 1.2 SG, which can include floatation in water. The heavies or heavier material 255 having an SG greater than 1.0 to 1.2 can be further processed because such material may contain valuable elements or discarded as waste (ABS/PS 257 or Metal/glass 258).

The light materials from the first gravity separation can be screened or cut or size separated 260 at between 2 mm or 8 mm, e.g., at 4 mm, 6 mm or 8 mm. The sizing may be carried out to produce sized waste streams with a particular desired particle size distribution to facilitate density separation and to produce intermediate streams enriched in particular recyclable materials. The material or overs from the size separation include the PP and PE 270.

Those skilled in the art will recognize that the comminuted waste stream can be analyzed to determine size cutoffs in which the fractions of the stream separate different types of materials into different streams while concentrating similar types of waste into somewhat concentrated streams. In addition, the sized waste streams may be optimized for density separation by creating a sized waste stream with a narrow distribution of particles. In one example the material is screened at 19 mm. The undersized materials from the screen can be further processed as those materials contain valuable elements. The over materials can include mixed plastic streams that can be subject to further purification steps to remove rubber and wood and to separate the plastics by type to achieve the desired composition, e.g., the composition purities described above. Suitable examples of a size separator that can be used in the present method include a disc screen separator with rubber or steel discs, a finger screen separator, a trommel screen separator, a vibratory screen separator, a waterfall screen, oscillating screen, flower disc screens, and/or other size separators.

The undersized materials having less than screen size can be comminuted or sheered. Generally, grinding is the process in a commercial mining operation in which larger fragments of ore are broken down to particles of fine particle sizes, i.e., the fines. The valuable minerals are extracted from the fines. The grinding process occurs in one or more means for comminuting mineral ore, such as ball mills, rod mills, autogenous mills, pebble mills, high pressure grinding mills, burnstone mills, vertical shift impactor mills, tower mills and the like. Ball mills, rod mills and high-pressure grinding roll mills can include specific embodiments. Such a comminution step does not grind or comminute plastics in the comminutor.

The materials from the ball mill or comminuted stage can be processed at a second density separation stage. During this stage, the material is separated at an SG of 1.2 or in a range from about 1.0 to 1.3 SG. In one example, materials under about or at 1.2 or the light materials are screened at between 4 mm to 8 mm, e.g., at 4 mm, 6 mm, 8 mm, or therebetween. In another example, the light materials about or at 1.2 or the light materials are screened at between 4 mm and 8 mm or 5 mm and 7 mm or at 6 mm. The unders or undersized materials at about 1.0 to 1.3 SG can contain wood, fuzz and generally less valuable materials or materials less desirable for PP/PE recycling or post processing.

The heavies from the first gravity separations are separated using a second gravity separation at about 1.2 SG. The heavies from a third separation are metals and glass. The lights are the ABS and PP, which are valuable and reduce landfill waste. The heavies include metals, glass, and brominated plastics, which can be further processed to obtain valuable materials.

Density separation can include froth flotation or other methods to facilitate the separation of plastics of similar density. Froth Flotation can be used in combination with other separation methods to achieve a desired purity. Other density separation techniques are known in the art.

The density separation steps may also be performed by the systems and methods termed falling velocity separators or jigs. Density differential alteration is a method to facilitate the separation of plastics of similar density.

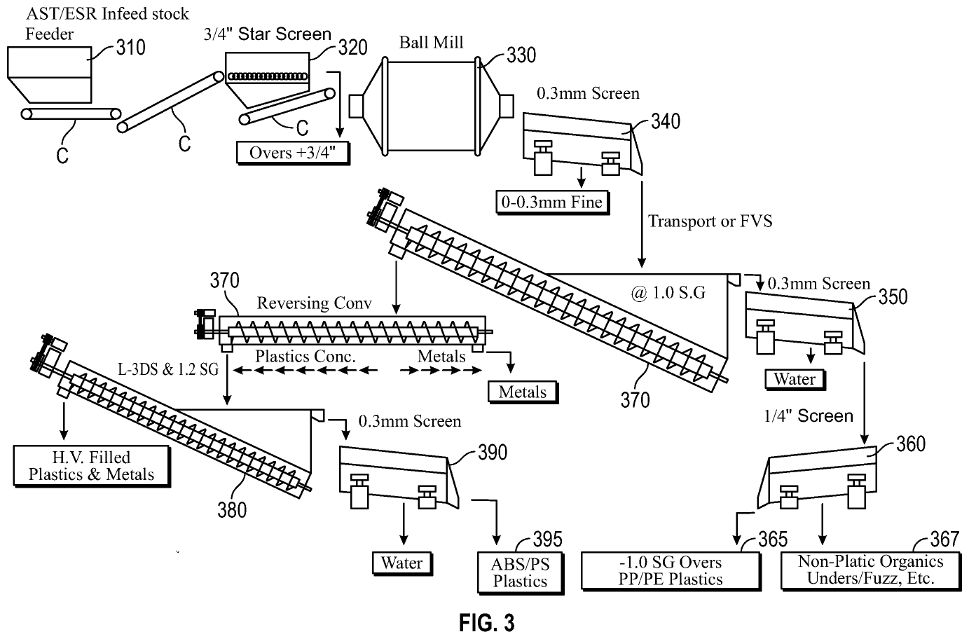

FIG. 3 shows an exemplary system 300 according to one embodiment. In this embodiment, the waste material, stored in a feeder 310, is screened at a first screen 320 to separate the material at between 19 mm and 25 mm or to cut/size separate the material at 19 mm or 25 mm into a first sized material and a first oversized material. The system includes (a) a comminutor (e.g., ball mill or rod mill) 330 for comminuting the sized material into a first residue by mechanical comminution, (b) a second screen 340 for sizing the first residue into a second sized material and a second oversized material, (c) a first density separator 370 at a specific density between 1.0 and 1.1 SG to separate the second oversized material into a first heavy fraction and a first light fraction, (d) a third screen 360 for separating the first light fraction at between at 0.3 mm and to cut/size separate at 3 mm and 8 mm into sized material and an oversized material, and (e) a collector (not shown) of the oversized material (overs). The 4 mm to 25 mm sized and less than 1.2 SG material can be more than 90% PP and PE 365. The oversized materials or overs are generally non-plastic material, fuzz and other material 367.

The system can also include a second density separator 375 for separating or sizing the second sized material at a specific density at 1 SG into a second heavy fraction and a second light fraction. This second density separator 375 can also be a reverse concentrator or screw.

The system can also include a third density separator 380 for separating or sizing the second sized material at a specific density at 1.2 SG into a third heavy fraction and a third light fraction.

The system can also include a fourth screen 390 for separating the third light fraction at between 0.3 mm and 0.50 mm into a fourth undersized material and a fourth oversized material, wherein the fourth oversized material is substantially ABS and PS. The system can also include a fourth sized material of the 1.2 SG fraction. The 1.2 SG light fraction yields a material cut at between 1.0 and 1.2 SG. This material can be dewatered and screened with 0.3 mm or 0.5 mm screen—the product can be ABS/PS plastics 395, which are valuable and recyclable.

There are methods for separating materials by density. Such methods typically feature the use of liquids as a suspending media for the separation of plastics by differential buoyancy and use components such as settling tanks, gravity concentration and hydrocyclones.

With regards to the waste stream, specific embodiments can be used to process waste materials or recyclable material that contains a concentration of plastics larger than 15%, or 25%, 35%, 45%, and/or 50%. This means that as long as there is a good concentration of plastics (as low as 20% or larger) the system can properly sort the materials. Household waste that has been presorted into “plastic and non-plastic” streams will be a good example. Typically household waste that is not landfilled can be presorted at a recycling facility where plastics separation will be generated. This plastics concentrate is one example of a “good feed material.” Municipal waste containing plastics is an exemplary waste stream material.

The plastics recycling processes can utilize a number of separation processes that are ordered to optimize efficiency and to create a valuable combination of products. The ordering can depend on the source, the particle size, and properties of the waste plastic material. In particular implementations, some operations can be repeated if required to achieve a desired purity or if the operations are required for different reasons at different stages in the process.

Although specific embodiments of the disclosure have been described above in detail, the description is merely for purposes of illustration. It should be appreciated, therefore, that many aspects of the disclosure were described above by way of example only and are not intended as required or essential elements of the disclosure unless explicitly stated otherwise. Various modifications of, and equivalent steps corresponding to, the disclosed aspects of the exemplary embodiments, in addition to those described above, can be made by a person of ordinary skill in the art, having the benefit of this disclosure, without departing from the spirit and scope of the invention defined in the following claims, the scope of which is to be accorded the broadest interpretation so as to encompass such modifications and equivalent structures.

1. A method for separating and recovering plastics from a waste stream, comprising the steps of:
a. Providing a waste material from the waste stream;
b. Size separating the waste material at between 19 to 25 mm into a first undersized material and a first oversized material;
c. Comminuting the first undersized material into a first residue by mechanical comminution;
d. Sizing the first residue into a second undersized material and a second oversized material;
e. Separating the second oversized material at a specific density between 1.0 and 1.1 SG into a first heavy fraction and a first light fraction;
f. Separating the first light fraction at greater than 4 mm into third undersized material and a third oversized material; and
g. Collecting the third oversized material, wherein the third sized oversized material is more than 90% PP and PE.

2. The method of claim 1, wherein the waste material provided in step (a) is selected from the group consisting of municipal solid waste, industrial waste, and electronic waste.

3. The method of claim 1, wherein the mechanical comminution in step (c) is carried out using a shredder, grinder, or pulverizer.

4. The method of claim 1, further comprising the step of washing the first residue to remove contaminants before sizing it in step (d).

5. The method of claim 1, wherein the specific density in step (e) is controlled using a liquid medium with a density between 1.0 and 1.1 SG.

6. The method of claim 1, wherein the first heavy fraction obtained in step (e) is further processed to remove non-polymeric materials before collecting the plastics.

7. The method of claim 1, wherein the third oversized material collected in step (g) undergoes further processing to produce plastic pellets.

8. The method of claim 1, wherein the plastic pellets produced from the third oversized material are suitable for reuse in the manufacture of plastic products.

9. The method of claim 1, further comprising monitoring and controlling the process parameters in real-time using sensors and automation to optimize plastic recovery efficiency.

10. The method of claim 1, wherein the plastic recovered in step (g) is sorted based on polymer type for recycling or resale.

11. A system for implementing the method of claim 1, comprising:
a. a waste material feeder;
b. a size separation unit;
c. a comminution unit;
d. a second sizing unit;
e. a first density separator;
f. a second size separation unit;
g. a collection system for plastics recovery;
h. a washing unit for cleaning the first residue; and
i. a control system for monitoring and controlling process parameters.

12. The system of claim 11, wherein the first density separator (e) includes a liquid density medium reservoir and an adjustable density control system.

13. The system of claim 11, further comprising a washing unit (h) equipped with water purification and recycling systems.

14. The system of claim 11, wherein the control system (i) includes sensors for monitoring particle size, density, and plastic content in real-time. The system of claim 11, further comprising a materials handling system for transporting the recovered plastics to downstream processing or storage facilities.

16. The system of claim 11, wherein the sizing unit (d) includes screens, classifiers, and sorting mechanisms for size separation.

17. The system of claim 11, further comprising a quality control unit for inspecting and sorting the recovered plastics based on polymer type.

18. The system of claim 11, wherein the control system (i) is capable of adjusting process parameters automatically to optimize plastic recovery efficiency.

19. The system of claim 11, further comprising an output conveyor system for transporting the recovered plastics to storage or further processing facilities. The system of claim 11, configured for continuous operation and capable of handling variable feed rates and waste material compositions.
